(19) United States
(12) Patent Application Publication
(10) Pub. No.: US 2025/0354869 A1
(43) Pub. Date: Nov. 20, 2025

(54) SENSING DEVICE AND IMAGE CAPTURING APPARATUS

(71) Applicant: Shenzhen Oceanwing Smart Innovations Technology Co., Ltd., Shenzhen (CN)

(72) Inventor: Xin Liu, Shenzhen (CN)

(21) Appl. No.: 19/202,491

(22) Filed: May 8, 2025

(30) Foreign Application Priority Data
May 14, 2024 (CN) 202421048466.4

(51) Int. Cl. G01J 5/08; G01J 5/00; G01J 5/02; G01J 5/0806; G01J 5/34; H04N 23/11; H04N 23/16; H04N 23/51

(52) U.S. Cl. CPC G01J 5/0893; G01J 5/0025; G01J 5/0205; G01J 5/0806; G01J 5/34; H04N 23/16; H04N 23/51; G01J 2005/0077; H04N 23/11

(57) ABSTRACT

Disclosed are a sensing device and an image capturing apparatus. The sensing device includes a housing assembly, a pyroelectric sensor disposed on the housing assembly, a Fresnel lens and a moving assembly. The Fresnel lens includes at least two Fresnel fringe areas with different light-condensing abilities; one of the pyroelectric sensor and the Fresnel lens is fixedly connected with the housing assembly, and another of the pyroelectric sensor and the Fresnel lens is movably coupled to the housing assembly through the moving assembly. The pyroelectric sensor and the Fresnel lens move relative to each other to switch between the Fresnel fringe area corresponding to the pyroelectric sensor. The disclosure can adjust the detection range and improve the multi-scene adaptability of the sensing device.

### CROSS-REFERENCE TO RELATED APPLICATION

The present disclosure claims priority to Chinese Patent Application No. 202421048466.4, filed on May 14, 2024, the entire disclosures of which are incorporated herein by reference.

### FIELD

The present disclosure relates to the technical field of sensing, in particular to a sensing device and an image capturing apparatus.

### BACKGROUND

Certain sensing devices include a pyroelectric sensor and a corresponding Fresnel lens. A detection distance or range of the sensing device varies due to different light-condensing abilities of the Fresnel lens. Thus, the detection range of the sensing device is generally fixed, leading to poor adaptability of the sensing device across multiple scenes.

### SUMMARY

The present disclosure provides a sensing device and an image capturing apparatus, which can adjust the detection range and improve the multi-scene adaptability of the sensing device.

In order to solve the above technical problem, the disclosure provides a sensing device comprising a housing assembly, a pyroelectric sensor provided or disposed on the housing assembly, a Fresnel lens and a moving assembly; the Fresnel lens includes at least two Fresnel fringe areas with different light-condensing abilities; one of the pyroelectric sensor and the Fresnel lens is fixedly connected with the housing assembly, and the other of the pyroelectric sensor and the Fresnel lens is movably connected or coupled to the housing assembly through the moving assembly; the pyroelectric sensor and the Fresnel lens are configured to move relative to each other to switch between the at least two Fresnel fringe areas corresponding to the pyroelectric sensor.

In order to solve the above technical problem, the disclosure further provides an image capturing apparatus. The image capturing apparatus includes the above sensing device and a lens, the sensing device is fixed on the lens or coupled to the lens through the housing assembly and is in communication connection with the lens. An image capturing area of the lens at least partially overlaps with a detection area of the sensing device, and the lens operates based on a detection result of the sensing device.

Beneficial effects of the disclosure include: the sensing device of the disclosure includes a housing assembly, a pyroelectric sensor, a Fresnel lens and a moving assembly, and the Fresnel lens includes at least two Fresnel fringe areas with different light-condensing abilities. The moving assembly facilitates relative movement between the pyroelectric sensor and the Fresnel lens, thereby enabling the switching between the Fresnel fringe areas with different light-condensing abilities to correspond with the pyroelectric sensor. As a result, infrared rays or light can pass through one of the Fresnel fringe areas and reach the pyroelectric sensor, allowing adjustment of the detection range of the sensing device, which, in turn, enhances the multi-scene applicability of the sensing device. Further, the Fresnel lens includes at least two Fresnel fringe areas with different light-condensing abilities. The arrangement of the moving assembly facilitates the switching between the Fresnel fringe areas with different light-condensing abilities to correspond to the pyroelectric sensor. As a result, the number of the pyroelectric sensors required can be reduced, along with the overall number of components in the sensing device, thereby lowering production and design cost, reducing a volume of the sensing device and enhancing structural simplicity. Still further, the housing assembly of this present disclosure is configured to provide positioning and constraint for the pyroelectric sensor, the Fresnel lens and the moving assembly, thereby enhancing the structural stability of the sensing device. Therefore, the sensing device of the present disclosure enables adjustable detection range, improves the multi-scene adaptability of the sensing device, reduces the number of components and overall volume, simplifies the structural, and lowers manufacturing cost.

### BRIEF DESCRIPTION OF THE DRAWINGS

In order to more clearly illustrate technical solutions in examples of the present disclosure, drawings that need to be used in description of the examples are briefly introduced below, and it will be apparent in to those of ordinary skill in the art that the drawings in the following description are only some examples of the disclosure, and other drawings can be obtained in accordance with these drawings without inventive work.

FIG. 1 is a structure diagram of an example of a sensing device of the present disclosure;

FIG. 2 is an exploded structure diagram of the example of FIG. 1;

FIG. 3 is a structure diagram of an example of a Fresnel lens and a first fixed member of the present disclosure;

FIG. 4 is a structure diagram of an example of a Fresnel lens of the present disclosure;

FIG. 5 is a cross-sectional structure diagram of a first fixed member, a Fresnel lens and a pyroelectric sensor in a first state;

FIG. 6 is a cross-sectional structure diagram of a first fixed member, a Fresnel lens and a pyroelectric sensor in a second state; and

FIG. 7 is a cross-sectional structure diagram of a first fixed member, a Fresnel lens and a pyroelectric sensor in a third state.

### DETAILED DESCRIPTION

In the following description, for the purpose of description rather than limitation, specific details such as specific system structures, and technologies are provided to facilitate a thorough understanding of examples of the present disclosure. However, it will be apparent to those skilled in the art that the present disclosure can be implemented in other examples without these specific details. In other cases, detailed description of well-known systems, devices, circuits, and methods are omitted so as not to obstruct description of the present disclosure with unnecessary details.

The terms “first”, “second”, and the like in the disclosure are used to distinguish different objects but not necessarily used to describe a particular order. Furthermore, the terms “comprising” and “having” and any variations thereof are intended to cover non-exclusive inclusion. It should be understood that the term “comprising” when used in the specification and the appended claims indicates the presence of the described features, integers, steps, operations, elements, and/or components, but does not exclude the presence or addition of one or more other features, integers, steps, operations, elements, components, and/or sets thereof. It should also be understood that the term used in the specification of the disclosure is merely for the purpose of describing particular examples and is not intended to limit the disclosure. As used in the specification and the appended claims of the disclosure, the singular forms “a”, “an” and “the” are intended to include the plural forms unless the context clearly dictates otherwise. It is further understood that the term “and/or” as used in the specification of the disclosure and the appended claims refers to any combination and all possible combinations of one or more of the associated listed items, and includes such combinations.

It should be noted that when an element is fixed to another element, it includes fixing the element directly to the other element or fixing the element to the other element by at least one middle element. When one element is connected to another element, it includes connecting the element directly to the other element, or connecting the element to the other element through at least one middle element.

Technical solutions in the present disclosure will be clearly and fully described with reference to the accompanying drawings in the present disclosure. Obviously, the examples to be described are merely part of the disclosure, but not all examples of the disclosure. Based on the examples of the disclosure, all other examples obtained by those of ordinary skill in the art without inventive work shall fall within the scope of the disclosure.

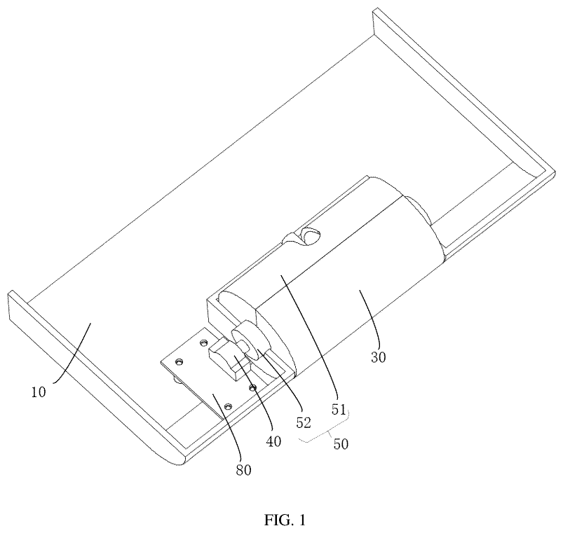

The disclosure first proposes a sensing device. As shown in FIGS. 1 to 7, the sensing device includes a housing assembly 10, a pyroelectric sensor 20, a Fresnel lens 30 and a moving assembly. The pyroelectric sensor 20 is provided or disposed on the housing assembly 10. The Fresnel lens 30 is provided or disposed on the housing assembly 10 and includes at least two Fresnel fringe areas 310 with different light-condensing abilities. One of the pyroelectric sensor 20 and the Fresnel lens 30 is fixedly connected with the housing assembly 10, and the other of the pyroelectric sensor 20 and the Fresnel lens 30 is movably connected or coupled to the housing assembly 10 through the moving assembly. The pyroelectric sensor 20 and the Fresnel lens 30 move relative to each other to switch between the Fresnel fringe areas 310 corresponding to the pyroelectric sensor 20, thus changing the light-condensing ability of the Fresnel lens 30 on the detection area, and changing a detection range of the sensing device.

The pyroelectric sensor 20 is a sensor that uses infrared light or rays to process data. The pyroelectric sensor 20 can detect infrared rays emitted by a human body and convert the infrared rays into electric signals for output. When certain crystals are heated, equal amount of opposite charges can be generated at both ends of the crystal. This polarization phenomenon caused by thermal change is called pyroelectric effect. The pyroelectric sensor 20 operates based on the pyroelectric effect, and functions as a temperature sensitive sensor. The sensing device can use the pyroelectric sensor 20 to detect a presence of a human body within its detection area.

The detection area of the sensing device is related to a detection area of the pyroelectric sensor and optical characteristics of an optical system. The detection area of pyroelectric sensor is an area where its receiving terminal can receive infrared radiation of infrared rays and generate electric signals. The detection area of pyroelectric sensor is determined by its internal structure which mainly includes a series of pyroelectric couples connected in series. Each of the pyroelectric couples constructed from films of two different materials, and these films form hot junctions at contact points. When the pyroelectric sensor is exposed to a temperature gradient, temperature difference between different materials may cause electrons to flow from a high temperature terminal to a low temperature terminal due to the Seebeck effect, thus generating the electrical signals. the establishment of the detection area of the sensing device usually involves factors such as the design parameters of the pyroelectric sensor, the temperature gradients, the optical characteristics of optical system, the environmental factors and the like. The design parameters of pyroelectric sensor determine a size and a shape of its sensitive area (e.g., the area within which detection can occur). The layout of pyroelectric elements in the sensor can be designed according to application requirements. Further, when the sensing device uses the pyroelectric sensor for infrared sensing, its detection area is also influenced by the optical system (such as a lens). The lens may condense (e.g., focus) or disperse (e.g., diffuse) incoming infrared radiation, thereby altering the size and shape of the overall detection area of the sensing device.

Therefore, a common sensing device usually includes a pyroelectric sensor 20 and a corresponding Fresnel lens 30, and the detection range of the sensing device is different due to different light-condensing abilities of the Fresnel lens 30. Because the common sensing device usually includes the pyroelectric sensor 20 and the Fresnel lens 30 with a non-adjustable light-condensing ability, the sensing device in the conventional system has a generally fixed detection range, with poor multi-scene applicability.

The Fresnel lens 30 is made according to the Fresnel principle, and the Fresnel lens 30 achieves light-condensing effect through the Fresnel fringe areas 310 thereon. The Fresnel lens 30, also known as a Fresnel zone lens or a planar lens, is a lens that condenses light by the diffraction principle of light. Compared with a conventional convex lens, the Fresnel lens 30 has a thinner structure and can be made by a simpler manufacturing process. A principle of condensing light of the Fresnel lens 30 is based on diffraction and interference. The Fresnel fringe area 310 is a series of concentric rings or zones, and each of the zones is equivalent to a tiny refractive element, and the zones act together on incident light. Design of the Fresnel fringe area 310 on the Fresnel lens 30 is generally based on Fresnel diffraction integral, and optical characteristics of the Fresnel fringe area 310 can be adjusted by accurately calculating a width and interval of each of the zones to control phase difference of light waves. In an application scenario, when parallel light is incident on the Fresnel fringe area 310, light waves on different zones diffract and interfere on the other side of the lens. Because a phase relationship of light is considered in the design, constructive interference may occur when these light waves meet at a focal point of the lens, thus enhancing light intensity at this point and realizing the light-condensing effect. For example, in a solar light-condensing system, the Fresnel lens 30 can condense sunlight on a small-area receiver, thus improving utilization of solar energy.

The light-condensing ability of the Fresnel lens 30 is affected by its design parameters, including a diameter, a focal length, the number and widths of zones, and the like. By optimizing these parameters, the desired concentrating performance can be obtained. Therefore, by incorporating the Fresnel lens 30 as an optical system in the sensing device to enhance the ability to concentrate external infrared radiation onto the pyroelectric sensor 20, the detection range and detection angle of the pyroelectric sensor 20 can be significantly increased, thereby greatly improving the sensitivity of the pyroelectric sensor 20.

Therefore, in order to improve structural simplicity, reduce overall volume, and production and design cost of the sensing device, the Fresnel lens 30 of this example includes at least two Fresnel fringe areas 310 with different light-condensing abilities (according to the above description, at least two Fresnel fringe areas 310 with different light-condensing abilities can be formed on the Fresnel lens 30 by adjusting design parameters of the lens). Moreover, the pyroelectric sensor 20 or the Fresnel lens 30 of this example can be movably connected or coupled to the housing assembly 10 through the moving assembly, and thus facilitate switching between the Fresnel fringe areas 310 with different light-condensing abilities to correspond to the pyroelectric sensor 20. Specifically, the Fresnel lens 30 can condense the incident infrared radiation through the Fresnel fringe areas 310. In an application scenario, specific structures (such as fringe characteristics) of the Fresnel fringe areas 310 can be designed according to the desired light-condensing ability, and the light-condensing ability of the Fresnel fringe areas 310 can be changed by changing structural characteristics of the Fresnel fringe areas 310. Specifically, because different structures of different Fresnel fringe areas 310 may result in different optical characteristics, different light-condensing abilities of different Fresnel fringe areas 310 can be realized. Because the Fresnel fringe area 310 with a stronger light-condensing ability can condense infrared radiation in an area at a larger range on the pyroelectric sensor 20. Therefore, with the Fresnel fringe area 310 of a stronger light-condensing ability, the pyroelectric sensor 20 can sense the infrared radiation in an area at a larger range, which means, the stronger the light-condensing ability of the Fresnel fringe area 310, the larger the detection range of the sensing device. Since the Fresnel lens 30 of this example includes at least two Fresnel fringe areas 310 with different light-condensing abilities, switching between the Fresnel fringe areas 310 allows infrared rays can be transmitted to the pyroelectric sensor 20 through the selected Fresnel fringe area 310 (e.g., achieving the aforementioned corresponding configuration). Because the Fresnel fringe areas 310 have different light-condensing abilities, switching between the Fresnel fringe areas 310 enables more convenient adjustment of the detection range of the sensing device.

The above arrangement has beneficial effects that the example sensing device o includes the housing assembly 10, the pyroelectric sensor 20, the Fresnel lens 30 and the moving assembly. The Fresnel lens 30 includes at least two Fresnel fringe areas 310 with different light-condensing abilities, the moving assembly facilitates relative movement between the pyroelectric sensor 20 and the Fresnel lens 30, and thus facilitates switching between the Fresnel fringe areas 310 with different light-condensing abilities to correspond to the pyroelectric sensor 20. Further, infrared rays can be transmitted to the pyroelectric sensor 20 through one of the Fresnel fringe areas 310, enabling adjustment of the detection range of the sensing device and improving the multi-scene applicability of the sensing device. Further, the Fresnel lens 30 includes at least two Fresnel fringe areas 310 with different light-condensing abilities, the arrangement of the moving assembly facilitates switching between the Fresnel fringe areas 310 with different light-condensing abilities to correspond to the pyroelectric sensor 20, thereby reducing the number of the pyroelectric sensors 20, the number of components of the sensing device, the production and design cost, and an overall volume of the sensing device, and enhancing structural simplicity. Still further, the housing assembly 10 of this example can provide positioning and constraint for the pyroelectric sensor 20, the Fresnel lens 30 and the moving assembly, thereby enhancing structural stability of the sensing device. Therefore, the example sensing device can adjust the detection range, improve the multi-scene adaptability of the sensing device, reduce the number of components and the volume, improve the structural simplicity, and reduce manufacturing cost.

Since the pyroelectric sensor 20 can communicate with external elements by connecting wires during use, in order to reduce operation interference to circuit units or sensors, the relative movement between the Fresnel lens 30 and the pyroelectric sensor 20 can be realized by moving the Fresnel lens 30.

For example, the pyroelectric sensor 20 is fixed to the housing assembly 10, the moving assembly includes a first rotating member 40, the Fresnel lens 30 is rotatably connected or coupled to the housing assembly 10 through the first rotating member 40, and the at least two Fresnel fringe areas 310 are arranged in sequence along a rotating direction of the Fresnel lens 30.

Specifically, the Fresnel fringe areas 310 with different light-condensing abilities are arranged in sequence along the rotation direction of the Fresnel lens 30. With rotation of the Fresnel lens 30, switching between the Fresnel fringe areas 310 with different light-condensing abilities to correspond to the pyroelectric sensors 20 can be realized, so that infrared rays can be transmitted to the pyroelectric sensor 20 through different Fresnel fringe areas 310, which facilitates adjustment of the detection range of the sensing device.

Therefore, in the above arrangement, the relative movement between the Fresnel lens 30 and the pyroelectric sensor 20 is realized through the rotation of the Fresnel lens 30. The pyroelectric sensor 20 is fixed to the housing assembly 10, which can readily reduce interference of the movement on a normal operation state of the pyroelectric sensor 20 (such as interference due to poor contact and the like), and thus can improve reliability of the sensing device. Further, in the above arrangement, the Fresnel lens 30 is rotated through the first rotating member 40. The first rotating member 40 can not only limit the Fresnel lens 30 and improve position stability thereof, but also realize the relative movement between the Fresnel lens 30 and the pyroelectric sensor 20 through the rotation, which better facilitates switching between the Fresnel fringe areas 310 with different light-condensing abilities to correspond to the pyroelectric sensor 20. Moreover, the rotating arrangement can reduce an active space occupied during the relative movement between the Fresnel lens 30 and the pyroelectric sensor 20, thereby further reducing the size of the sensing device, the design complexity, and the production cost of the sensing device, so that integration and aesthetics of the sensing device can be improved.

Of course, in other examples, the relative movement between the Fresnel lens and the pyroelectric sensor can be realized by movement of the pyroelectric sensor or joint movement of the Fresnel lens and the pyroelectric sensor, which is not specifically limited.

In other examples, a mode of movement is not limited and may include, for example, translational movement or other forms of displacement, which are not specifically limited herein.

For example, the Fresnel lens 30 includes a side part 31 and an end part 32. The side part 31 is provided with the at least two Fresnel fringe areas 310 and is in an arc, and the end part 32 is connected with the first rotating member 40. Specifically, the side part 31 of the Fresnel lens 30 is bent into an arc, and the end part 32 is connected with the side part 31.

Specifically, a mode of connection of the end part 32 and the side part 31 is not limited. For example, the end part 32 and the side part 31 may be connected by gluing or the like. In other examples, the end part 32 and the side part 31 may be integrally formed. For example, the side part 31 and the end part 32 of the Fresnel lens 30 can be formed by injection molding, which is a common method for manufacturing the Fresnel lens 30, in which a mold of the Fresnel lens 30 can be first designed, then molten plastic is injected into the mold at high temperature and high pressure, and the molded lens can be obtained after cooling and curing. The injection molding is suitable for mass production with low cost, and can realize accurate manufacturing of complex shapes.

The above arrangement has beneficial effects that the side part 31 of the Fresnel lens 30 is in an arc and provided with at least two Fresnel fringe areas 310, which facilitates switching between the Fresnel fringe areas 310 with different light-condensing abilities to correspond to the pyroelectric sensor 20 by rotation with a simple structure. The end 32 of the Fresnel lens 30 is connected with the first rotating member 40, which enhances of the structural stability of the Fresnel lens 30.

For example, the pyroelectric sensor 20 is provided at a center of the arc. The side part 31 of the Fresnel lens 30 is bent in an arc, and the pyroelectric sensor 20 is provided at the center of the arc.

This arrangement facilitates control of the Fresnel lens 30 to rotate to realize correspondence of the Fresnel fringe areas 310 with different light-condensing abilities to the pyroelectric sensor 20, and facilitates improving an infrared light-condensing effect of the Fresnel fringe areas 310 on the pyroelectric sensor 20.

In other examples, the side part of the Fresnel lens is enclosed to form a cylinder, and the pyroelectric sensor is provided at a circle center, e.g., at a center of the cylinder.

For example, the moving assembly further includes a first fixed member 50 connected with the first rotating member 40; the Fresnel lens 30 and the first fixed member 50 are connected and form a hollow cavity 01. For example, the Fresnel lens 30 and the first fixed member 50 are connected with each other to enclose the hollow cavity 01. The pyroelectric sensor 20 is provided in the hollow cavity 01.

In an application scenario, the Fresnel lens 30 is fixed on the first fixed member 50, and the first fixed member 50 rotates synchronously with the Fresnel lens 30. The first fixed member 50 is connected with the first rotating member 40 to realize connection between the Fresnel lens 30 and the first rotating member 40, which can improve the structural stability of the Fresnel lens 30. Further, the Fresnel lens 30 and the first fixed member 50 are connected to form the hollow cavity 01. For example, the Fresnel lens 30 and the first fixed member 50 are connected with each other to enclose the hollow cavity 01. The pyroelectric sensor 20 is provided in the hollow cavity 01, which facilitates switching the Fresnel fringe areas 310 with different light-condensing abilities to correspond to the pyroelectric sensor 20 when the Fresnel lens 30 rotates, can reduce interference of the Fresnel lens 30 in the pyroelectric sensor 20, and can reduce interference of external environment in the pyroelectric sensor 20, and thus can improve reliability of the sensing device and facilitate production and assembly. Of course, in other examples, the Fresnel lens can be directly connected with the first rotating member, as long as the Fresnel lens can be connected with the first rotating member, which is not specifically limited.

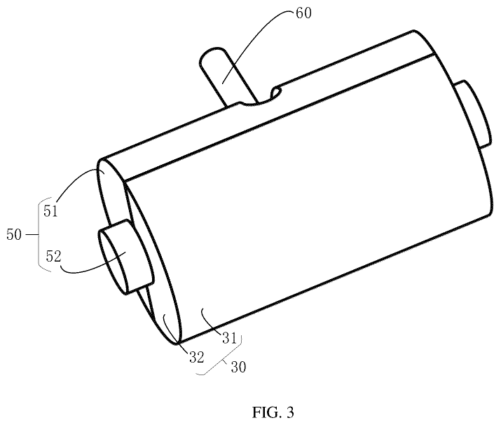

In an application scenario, as shown in FIG. 3, the Fresnel lens 30 and the first fixed member 50 are connected to enclose a cylinder and the hollow cavity 01, which facilitates rotation. Of course, in other examples, a specific shape of a structure formed by connecting the Fresnel lens and the first fixed member is not limited, as long as the hollow cavity can be formed, which is not specifically limited. Of course, in other examples, the Fresnel lens can form the cylinder and the hollow cavity alone, which is not specifically limited.

For example, the first fixed member 50 is provided with an avoidance hole 02, and the sensing device further includes a second fixed member 60, one end of the second fixed member 60 is connected with the pyroelectric sensor 20, and the other end of the second fixed member 60 passes through the avoidance hole 02 and extends out of the hollow cavity 01 and is fixedly connected with the housing assembly 10. Specifically, the second fixed member 60 can fix the pyroelectric sensor 20, so as to fix the pyroelectric sensor 20 in the hollow cavity 01.

The above arrangement has beneficial effects that the first fixed member 50 is provided with the avoidance hole 02, so that the second fixed member 60 can pass through the avoidance hole 02 and extend out of the hollow cavity 01 to be fixedly connected with the housing assembly 10, and thus the pyroelectric sensor 20 can be fixed to the housing assembly 10. Therefore, provision of the avoidance hole 02 and the second fixed member 60 can improve convenience of installation and fixation of the pyroelectric sensor 20 and improve position stability of the pyroelectric sensor 20.

For example, in an application scenario, as shown in FIG. 3, the Fresnel lens 30 and the first fixed member 50 are connected to form or enclose the cylinder and the hollow cavity 01, the Fresnel lens 30 is fixed on the first fixed member 50, and the first fixed member 50 rotates synchronously with the Fresnel lens 30. The first fixed member 50 includes an end part and a side part, and the side part of the first fixed member 50 and the side part 31 of the Fresnel lens 30 are connected to form a side wall of the cylinder, and the end part of the first fixed member 50 is connected with the end part 32 of the Fresnel lens 30 to form a bottom wall of the cylinder. The avoidance hole 02 is provided on the side part of the first fixed member 50 and extends along a rotation direction of the first fixed member 50. This arrangement can reduce rotation interference of the second fixed member 60 in the first fixed member 50 and the Fresnel lens 30.

In other examples, the avoidance hole can be provided on a bottom wall of an end of the cylinder, one end of the second fixed member is connected with the pyroelectric sensor, and the other end of the second fixed member passes through the avoidance hole on an end wall, extends out of the hollow cavity, and is fixedly connected with the housing assembly.

For example, the first rotating member 40 includes a magnetic encoding switch. The magnetic encoding switch is a magnetic encoder which can obtain rotation position information by detecting magnetic field change and convert the rotation position information into an electrical signal for output.

Specifically, when the Fresnel lens 30 rotates, the magnetic encoding switch can provide damping to realize rotation limit of the Fresnel lens 30; and can also obtain rotation angle information to be output to external elements such as a mobile phone.

The magnetic encoding switch can realize rotation limit of the Fresnel lens 30, improve position stability of the Fresnel lens 30 during rotation and after rotation, obtain and output the rotation angle information to the external elements, facilitate users to know rotation angle information of the Fresnel lens 30 and thus a current detection range of the sensing device, and thus facilitate the users to adjust the detection range of the sensing device.

For example, the magnetic encoding switch includes a wireless communication module and/or a wired communication module to realize signal transmission with the external elements. In an application scenario, the magnetic encoding switch can transmit the rotation angle information to application software of a mobile phone through the wireless communication module, and the user can check a rotation angle and/or a corresponding detection range in real time through the application software.

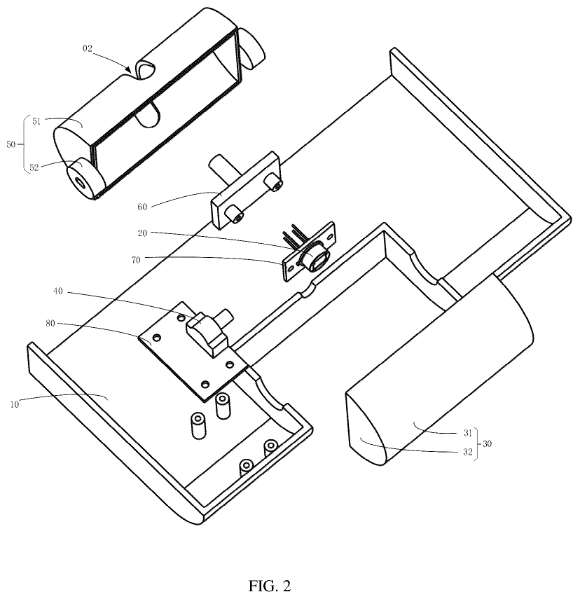

For example, in an application scenario, as shown in FIGS. 2 and 3, the first fixed member 50 includes a body part 51 and a rotating shaft 52. The body part 51 and the Fresnel lens 30 are connected to form the hollow cavity 01. For example, the Fresnel lens 30 and the body part 51 are connected with each other to enclose the hollow cavity 01. The rotating shaft 52 is fixedly connected with the first rotating member 40 (such as the magnetic encoding switch), and the first rotating member 40 is rotatably connected with the housing assembly 10, so that the Fresnel lens 30 is rotatably connected with the housing assembly 10.

The first fixed member 50 is fixedly connected with the Fresnel lens 30 to realize fixed connection of the first rotating member 40 (e.g., the magnetic encoding switch) and the Fresnel lens 30, which can improve the position stability of the Fresnel lens 30. In an application scenario, when the Fresnel lens 30 rotates, the Fresnel lens 30 drives the first fixed member 50 to rotate and then drives the magnetic encoding switch to rotate, so that the magnetic encoding switch can obtain the rotation angle, provide damping for rotation and realize rotation limit, and the Fresnel lens 30 can stably rest at a position after rotating a certain angle.

For example, as shown in FIG. 2, the rotating shaft 52 is provided with a recessed part and the magnetic encoding switch is provided with a protruding part, and engagement between the protruding part and the recessed part is fixed, so as to realize fixed positioning of the rotating shaft 52 and the magnetic encoding switch. In other examples, fixed connection between the rotating shaft and the magnetic encoding switch, fixed connection between the first fixed member and the magnetic encoding switch, or fixed connection between the Fresnel lens and the magnetic encoding switch can also be realized by welding, pasting and the like, which is not specifically limited.

For example, as shown in FIG. 1, the sensing device further includes a third fixed member 80. The third fixed member 80 is fixedly connected with the housing assembly 10 and rotatably connected with the magnetic encoding switch, which means, the magnetic encoding switch is rotatably connected or coupled to the housing assembly 10 through the third fixed member 80.

In other examples, the magnetic encoding switch can also be fixedly connected with the housing assembly and rotatably connected with the Fresnel lens 30, which is not specifically limited.

Because the different light-condensing abilities of the Fresnel fringe areas 310 may result in different detection ranges of the sensing device, arrangement of the Fresnel fringe areas 310 with different light-condensing abilities can be optimized in order to improve convenience of adjusting the detection range of the sensing device. For example, light-condensing abilities of the at least two Fresnel fringe areas 310 increase sequentially along an arrangement direction of the Fresnel fringe areas 310.

In an application scenario, as shown in FIGS. 1 and 4 to 7, the first fixed member 50 and the Fresnel lens 30 are enclosed to form a cylinder, and the Fresnel lens 30 can rotate around a central axis of the cylinder. A first Fresnel fringe area 311, a second Fresnel fringe area 312 and a third Fresnel fringe area 313 are sequentially arranged along the rotation direction of the Fresnel lens. Light-condensing abilities of the first Fresnel fringe area 311, the second Fresnel fringe area 312 and the third Fresnel fringe area 313 decrease sequentially according to an arrangement order of the Fresnel fringe areas 310. In this arrangement, relationship of the light-condensing abilities of the three areas is: the first Fresnel fringe area 311>the second Fresnel fringe area 312>the third Fresnel fringe area 313. In other examples, the light-condensing abilities of the three areas can also be set to increase sequentially, which means, the relationship of the light-condensing abilities of the three areas is: the first Fresnel fringe area 311<the second Fresnel fringe area 312<the third Fresnel fringe area 313. This is not specifically limited.

This arrangement enables the users to adjust the detection range of the sensing device in a manner varying from large to small or from small to large by adjusting the relative movement of the pyroelectric sensor 20 and the Fresnel lens 30, which conforms to common sense of the users and improves use experience.

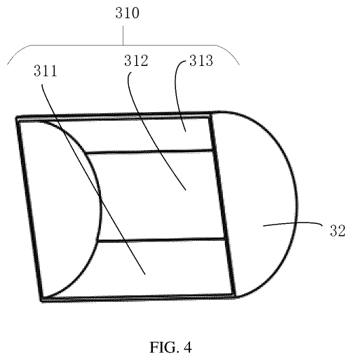

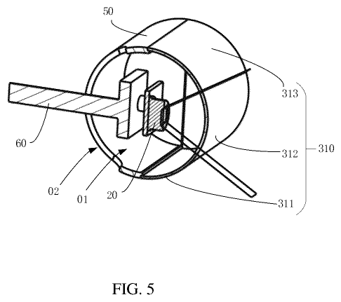

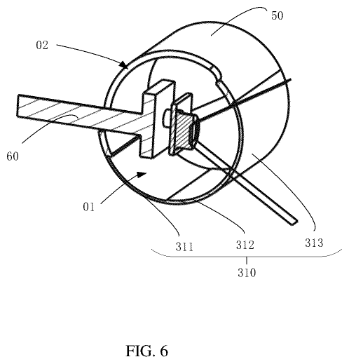

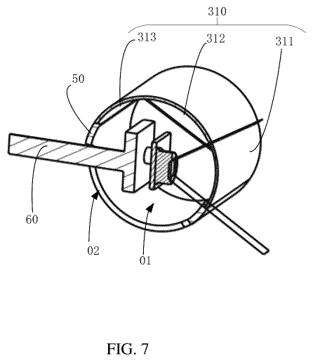

The stronger the light-condensing ability of the Fresnel lens 30, the larger the detection range. For example, in some examples, as shown in FIGS. 4 to 7, the side part 31 of the Fresnel lens 30 is provided in an arc with a central angle of 180°. The Fresnel lens 30 includes a first Fresnel fringe area 311, a second Fresnel fringe area 312, a third Fresnel fringe area 313 with sequentially decreasing light-condensing abilities, and the first Fresnel fringe area 311, the second Fresnel fringe area 312 and the third Fresnel fringe area 313 each have a central angle of 60°. As shown in FIG. 7, when the first Fresnel fringe area 311 corresponds to the pyroelectric sensor 20, the detection range of the sensing device is at a large level. As shown in FIG. 5, when the second Fresnel fringe area 312 corresponds to the pyroelectric sensor 20, the detection range of the sensing device is at a middle level. As shown in FIG. 6, when the third Fresnel fringe area 313 corresponds to the pyroelectric sensor 20, the detection range of the sensing device is at a small level.

Because central angles corresponding to the Fresnel fringe areas 310 may also affect light-condensing effects thereof, this arrangement can not only make the detection range of the sensing device meet daily use needs of the users and improve practicability, but also increase options of the detection range of the sensing device, improve the multi-scene applicability of the sensing device and improve the user experience. The side part 31 of the Fresnel lens 30 is provided in an arc with the central angle of 180°, which facilitates provision of the first fixed member 50 and the avoidance hole 02 on the first fixed member 50, and can increase a central angle corresponding to the side part 31 of the Fresnel lens 30 while improving rotational stability of the Fresnel lens 30. For example, in an application scenario, when the rotation angle of the Fresnel lens 30 is 0°, the detection range of the sensing device is at a middle level.

For example, the detection range of the sensing device can be set at a small level with a detectable range of 5 to 7 meters. The detection range of the sensing device can be set at a middle level with a detectable range of 7 to 9 meters. The detection range of the sensing device can be set at a large level with a detectable range of more than 9 meters. This setting conforms to user's daily application scenario and improves the scene applicability of the sensing device.

For example, in other examples, the light-condensing abilities of the at least two Fresnel fringe areas 310 can decrease sequentially in an arrangement order thereof along an arrangement direction thereof, which is not specifically limited.

In other examples, the side part of the Fresnel lens can further be provided with two or four or more Fresnel fringe areas with different light-condensing abilities, and arrangement of a plurality of the Fresnel fringe areas can be realized by adjusting the central angles corresponding to the Fresnel fringe areas or central angles corresponding to the side parts of the Fresnel lens.

For example, the Fresnel fringe areas 310 of the Fresnel lens 30 can be adjusted based on an application scenario of a product, for example, fringe characteristics of the Fresnel fringe areas 310 can be adjusted to realize adjustment of optional detection ranges of the sensing device. For example, the user can manually control rotation of the Fresnel lens 30 to realize adjustment of the detection range of the sensing device.

For example, the sensing device includes a driving member. The driving member is in transmission connection with the Fresnel lens 30, the pyroelectric sensor 20 or the moving assembly (for example, the first rotating member 40), and is configured to realize the relative movement between the pyroelectric sensor 20 and the Fresnel lens 30, and thus one of the at least two Fresnel fringe areas 310 is switched to correspond to the pyroelectric sensor 20, so that infrared rays are transmitted to the pyroelectric sensor 20 through the corresponding Fresnel fringe area 310, which means, an adjustment of the detection range of the sensing device can be realized.

For example, as shown in FIG. 2, the sensing device further includes a printed circuit board (PCB) 70, the pyroelectric sensor 20 is provided on the PCB, and the PCB is provided on the second fixed member 60.

For example, the driving member of this example can be a motor, a cylinder or the like, or the driving can be manual, which is not specifically limited.

In some examples, the housing assembly 10 is provided with a groove, the Fresnel lens 30 is at least partially located in the groove, and the Fresnel fringe area 310 is provided toward an opening direction of the groove. This arrangement facilitates fixing of the Fresnel lens 30, and the Fresnel fringe area 310 is provided toward the opening direction of the groove, which can reduce shielding effect of the housing assembly 10 on infrared rays and improve sensing effect of the sensing device. In other examples, similar improvements can be made on the sensing device, which is not repeated here.

The disclosure further provides an image capturing apparatus. The image capturing apparatus includes the sensing device and a lens. The sensing device is fixed on the lens or coupled to the lens through the housing assembly and is in communication connection with the lens, an image capturing area of the lens at least partially overlaps with a detection area of the sensing device, and the lens operates based on a detection result of the sensing device.

In an application scenario, the lens includes an image acquisition assembly and a control chip. The control chip communicates with the sensing device and controls the image acquisition assembly to operate based on the detection result of the sensing device. The image capturing area of the lens at least partially overlaps with the detection area of the sensing device. For example, in an application scenario, when the sensing device detects that there is a human body in the detection area, the lens can start image capturing based on the detection result of the sensing device.

A specific implementation and operation principle of the sensing device can refer to the above examples, which is not repeated here. This arrangement has beneficial effects that the lens communicates with the sensing device, can operate based on the detection result of the sensing device, and can improve functional diversity and sensitivity of the image capturing apparatus.

For example, the image capturing apparatus of this example includes a security camera which can be used for various security scenes such as doorbell image capturing and home monitoring. The security camera is an acquisition device that converts a light image on a target surface of an image sensor in a range from visible light to near infrared spectrum into a video image signal for purposes of security and video monitoring.

For example, the lens further includes a second rotating assembly for controlling rotation of the lens. Specifically, the second rotating assembly can control the rotation of the lens. It should be noted that the rotation of the lens and rotation of the Fresnel lens are independent of and do not interfere with each other.

For example, the image capturing apparatus further includes a controller which is in communication connection with the sensing device, and the controller can control the lens to start capturing an image based on the detection result of the sensing device. This arrangement can improve sensitivity of the image capturing apparatus.

For example, the image capturing apparatus further includes a driving member, and the controller can control the driving member to drive the second rotating assembly to operate based on the detection result of the sensing device to realize rotation control of the lens.

Different from the related art, the sensing device of the disclosure includes the housing assembly, the pyroelectric sensor, the Fresnel lens and the moving assembly. The Fresnel lens includes at least two Fresnel fringe areas with different light-condensing abilities, the moving assembly facilitates realizing relative movement between the pyroelectric sensor and the Fresnel lens, and thus facilitates switching between the Fresnel fringe areas with different light-condensing abilities to correspond to the pyroelectric sensor. Infrared rays can be transmitted to the pyroelectric sensor through one of the Fresnel fringe areas, which can realize adjustment of the detection range of the sensing device and thus can improve the multi-scene applicability of the sensing device. Further, the Fresnel lens includes at least two Fresnel fringe areas with different light-condensing abilities, the arrangement of the moving assembly facilitates switching between the Fresnel fringe areas with different light-condensing abilities to correspond to the pyroelectric sensor, which thus can reduce the number of the pyroelectric sensors, the number of components of the sensing device, and production and design cost, and can reduce a volume of the sensing device and improve structural simplicity. Still further, the housing assembly of this example can provide positioning and restraint for the pyroelectric sensor, the Fresnel lens and the moving assembly, and can improve structural stability of the sensing device. Therefore, the sensing device of this example can adjust the detection range, improve the multi-scene adaptability of the sensing device, reduce the number of components and the volume, enhance the structural simplicity, and reduce the manufacturing cost.

It is worth noting that the accompanying drawings herein are merely for illustrating the structural relationship and connection relationship of the products of the present disclosure, but do not limit the specific structural dimensions of the products of the present disclosure.

The above are only preferred examples of the present disclosure and do not limit the scope of the disclosure. Transformation of an equivalent structure or process made with the contents of the specification and drawings of the present disclosure is directly or indirectly used in other related technical fields, and should be included in the protection scope of the present disclosure.

What is claimed is:

1. A sensing device comprising:
a housing assembly,
a pyroelectric sensor disposed on the housing assembly,
a Fresnel lens, and
a moving assembly, wherein:
the Fresnel lens comprises at least two Fresnel fringe areas with different light-condensing abilities;
one of the pyroelectric sensor and the Fresnel lens is fixedly connected with the housing assembly, and another of the pyroelectric sensor and the Fresnel lens is movably coupled to the housing assembly through the moving assembly; and
the pyroelectric sensor and the Fresnel lens are configured to move relative to each other to switch between the at least two Fresnel fringe areas.

2. The sensing device of claim 1, wherein the pyroelectric sensor is fixed to the housing assembly, the moving assembly comprises a first rotating member, the Fresnel lens is rotatably coupled to the housing assembly through the first rotating member; and
the at least two Fresnel fringe areas are arranged in sequence along a rotating direction of the Fresnel lens.

3. The sensing device of claim 2, wherein the Fresnel lens comprises a side part and an end part, the side part is provided with the at least two Fresnel fringe areas and is in an arc, and the end part is connected with the first rotating member.

4. The sensing device of claim 3, wherein the pyroelectric sensor is provided at a center of the arc.

5. The sensing device of claim 2, wherein the moving assembly further comprises:
a first fixed member connected with the first rotating member, wherein the Fresnel lens and the first fixed member are connected to enclose a hollow cavity, and the pyroelectric sensor is disposed within the hollow cavity.

6. The sensing device of claim 5, wherein the first fixed member comprises:
a body part is connected with the Fresnel lens to enclose the hollow cavity; and
a rotating shaft fixedly connected with the first rotating member, wherein the first rotating member is rotatably connected with the housing assembly, so that the Fresnel lens is rotatably coupled to the housing assembly.

7. The sensing device of claim 5, wherein the first fixed member is provided with an avoidance hole, and the sensing device further comprises:
a second fixed member, one end of which is connected with the pyroelectric sensor, and another end of which passes through the avoidance hole and extends out of the hollow cavity and is fixedly connected with the housing assembly.

8. The sensing device of claim 2, wherein the first rotating member comprises a magnetic encoding switch.

9. The sensing device of claim 1, wherein light-condensing abilities of the at least two Fresnel fringe areas increase sequentially along an arrangement direction of the Fresnel fringe areas.

10. An image capturing apparatus comprising:
a lens; and
a sensing device, wherein the sensing device is coupled to the lens through a housing assembly and is communicatively coupled to the lens, an image capturing area of the lens at least partially overlaps with a detection area of the sensing device, and the lens is configured to operate based on a detection result of the sensing device, and
the sensing device comprising:
the housing assembly,
a pyroelectric sensor disposed on the housing assembly,
a Fresnel lens and
a moving assembly, and wherein:
the Fresnel lens comprises at least two Fresnel fringe areas with different light-condensing abilities;
one of the pyroelectric sensor and the Fresnel lens is fixedly connected with the housing assembly, and another of the pyroelectric sensor and the Fresnel lens is movably coupled to the housing assembly through the moving assembly; and
the pyroelectric sensor and the Fresnel lens are configured to move relative to each other to switch between the at least two Fresnel fringe areas.

11. The image capturing apparatus of claim 10, wherein the pyroelectric sensor is fixed to the housing assembly, the moving assembly comprises a first rotating member, the Fresnel lens is rotatably coupled to the housing assembly through the first rotating member; and
the at least two Fresnel fringe areas are arranged in sequence along a rotating direction of the Fresnel lens.

12. The image capturing apparatus of claim 11, wherein the Fresnel lens comprises a side part and an end part, the side part is provided with the at least two Fresnel fringe areas and is in an arc, and the end part is connected with the first rotating member.

13. The image capturing apparatus of claim 12, wherein the pyroelectric sensor is provided at a center of the arc.

14. The image capturing apparatus of claim 11, wherein the moving assembly further comprises:
a first fixed member connected with the first rotating member, wherein the Fresnel lens and the first fixed member are connected to enclose a hollow cavity, and the pyroelectric sensor is disposed within the hollow cavity.

15. The image capturing apparatus of claim 14, wherein the first fixed member comprises:
a body part is connected with the Fresnel lens to enclose the hollow cavity; and
a rotating shaft fixedly connected with the first rotating member, wherein the first rotating member is rotatably connected with the housing assembly, so that the Fresnel lens is rotatably coupled to the housing assembly.

16. The image capturing apparatus of claim 14, wherein the first fixed member is provided with an avoidance hole, and the sensing device further comprises:
a second fixed member, one end of which is connected with the pyroelectric sensor, and another end of which passes through the avoidance hole and extends out of the hollow cavity and is fixedly connected with the housing assembly.

17. The image capturing apparatus of claim 11, wherein the first rotating member comprises a magnetic encoding switch.

18. The image capturing apparatus of claim 10, wherein light-condensing abilities of the at least two Fresnel fringe areas increase sequentially along an arrangement direction of the Fresnel fringe areas.

19. A security system comprising:
an image capturing apparatus comprising a lens and a sensing device, and
a controller configured to control the lens to start capturing an image based on a detection result of the sensing device,
wherein the sensing device comprise a pyroelectric sensor and a Fresnel lens, and wherein:
the Fresnel lens comprises at least two Fresnel fringe areas with different light-condensing abilities; and
the pyroelectric sensor and the Fresnel lens are configured to move relative to each other to switch between the at least two Fresnel fringe areas.

20. The security system of claim 19, wherein the sensing device is coupled to the lens through a housing assembly and is in communication connection with the lens, an image capturing area of the lens at least partially overlaps with a detection area of the sensing device.
